(19) United States
(12) Patent Application Publication
(10) Pub. No.: US 2022/0280264 A1
(43) Pub. Date: Sep. 8, 2022

(54) METHOD FOR GENERATING BENDING PATH OF ORTHODONTIC WIRE

(71) Applicant: YOAT Corporation, Daejeon (KR)

(72) Inventors: YOUN HO JUNG, Seoul (KR); JAE WOONG JUNG, Seoul (KR)

(21) Appl. No.: 17/193,170

(22) Filed: Mar. 5, 2021

(51) Int. Cl. A61C 7/00; A61C 7/20

(52) U.S. Cl. CPC A61C 7/002; A61C 7/20

(57) ABSTRACT

A method for generating a bending path of an orthodontic wire according to an embodiment of the present disclosure includes generating scan data for a plurality of teeth in an oral cavity of a target patient by using a three-dimensional (3D) scanner, generating a virtual 3D tooth model through the generated scan data, determining one of a maxillary and a mandible for the virtual 3D tooth model, generating an occlusal plane for the virtual 3D tooth model and a virtual plane parallel to the occlusal plane, generating an occlusal surface where the virtual plane and the virtual 3D tooth model meet, generating a virtual point along the occlusal surface to generate a bending path of a wire, and outputting the bending path of the wire.

### BACKGROUND

### 1. Technical Field

Embodiments of the present invention disclosed herein relate to a method for generating a bending path of an orthodontic wire.

### 2. Background Art

Dental treatment refers to a series of treatments aimed at preventing, diagnosing, and treating diseases or abnormal conditions in teeth and surrounding tissues thereof, and a maxillofacial region, including an oral cavity.

In recent years, a lot of orthodontic treatments have been performed in addition to the treatment necessary to improve oral hygiene and maintain healthy teeth. The orthodontic treatment involves not only simply straightening crooked teeth and but also correcting various skeletal incongruities that may occur during the growing years to function normally, thereby making the oral tissue healthy and making the face look more beautiful.

Orthodontic wires are widely used in the orthodontic treatment process. A prerequisite for shortening the treatment period and improving the treatment effect is to produce an orthodontic wire in an accurate shape depending on a tooth structure of the teeth arrangement and tooth shape of an orthodontic patient. Therefore, for the successful orthodontic treatment, the orthodontic wire should be elaborately formed depending on the oral structure of each patient.

A method for forming the orthodontic wires has often been performed manually by a dentist or dental technician after constructing a frame (model) in which the pattern of the oral cavity including teeth is replicated.

When the orthodontic wire is formed by the manual method as described above, the quality of the forming of the orthodontic wire can be influenced and the work cost and working time can be greatly increased by the skill level of an operator, which acts as a factor of increasing the orthodontic treatment cost.

Therefore, there is a demand for a bending method capable of simplifying a method for forming a wire, and reducing the cost of bending forming of the orthodontic wire.

### SUMMARY

Embodiments of the present invention are to provide a method for generating a bending path of an orthodontic wire.

In addition, embodiments of the present invention are to provide a means for simply forming a wire along a wire bending path to reduce the cost of the bending forming of the orthodontic wire.

According to an aspect of the present invention, there is provided a method for generating a bending path of an orthodontic wire, the method including generating scan data for a plurality of teeth in an oral cavity of a target patient by using a three-dimensional (3D) scanner, generating a virtual 3D tooth model through the generated scan data, determining one of a maxillary and a mandible for the virtual 3D tooth model, generating an occlusal plane for the virtual 3D tooth model and a virtual plane parallel to the occlusal plane, generating an occlusal surface where the virtual plane and the virtual 3D tooth model meet, generating a virtual point along the occlusal surface to generate a bending path of a wire, and outputting the bending path of the wire.

The generating of the scan data may include acquiring a tooth shape by using an impression material for the plurality of teeth and then producing a gypsum model therefor, and generating the scan data by using the 3D scanner for the produced gypsum model.

The generating of the scan data may include generating the scan data for the plurality of teeth by directly using the 3D scanner.

The determining of one of the maxillary and the mandible for the virtual 3D tooth model may be based on a direction in which a plurality of positions on the virtual 3D tooth model are selected.

The plurality of positions may be three in number.

The occlusal plane of the 3D tooth model may be a virtual plane obtained by connecting the three or more highest points of the plurality of teeth.

The occlusal plane may be formed for each of the maxillary and the mandible of the plurality of teeth.

At least one of the inclination and height of the virtual plane may be adjusted.

The bending path of the wire may generate at least three virtual points for each tooth.

The virtual points may be three or more points generated at a central portion of each tooth and right and left borders to the central portion.

The virtual points may be adjustable right, left, front, back, up, and down, and controlled in only one direction during the position movement.

The virtual points may be additionally generated between the central portion of each tooth and each of the right and left borders to the central portion.

The bending path of the wire may be generated such that the wire does not penetrate a boundary of the occlusal surface by setting a thickness of the wire.

Output data for the bending path of the wire may correspond to a line connecting a center point of a vertical section of the wire.

According to another aspect of the present invention, there is a computer storage medium storing a program for performing the method for generating a bending path of an orthodontic wire.

According to still another aspect of the present invention, there is provide a wire manufacturing apparatus including a control board for transforming coordinates for bending a wire through data output by the method for generating a bending path of an orthodontic wire, in which a motor of a machine is controlled through the transformed coordinates, and the bending is performed with a shape of the wire designed through the transformed coordinates.

According to still another aspect of the present invention, there is provided a wire manufactured by the wire manufacturing apparatus.

According to the disclosed embodiments, it is possible to easily set the forming path of the orthodontic wire by generating the 3D tooth model for a plurality of teeth in the oral cavity of a target patient by using the 3D scanner and generating an occlusal plane and a virtual plane for the generated 3D tooth model to generate a wire bending path along an occlusal surface where the occlusal plane and the virtual plane meet.

In addition, according to the disclosed embodiments, since the wire manufacturing apparatus manufactures the wire based on the set wire path, it is not necessary to perform separate manual work, and thus it is possible to simplify the method for forming the wire and reduce the work cost and the working time.

### BRIEF DESCRIPTION OF THE DRAWINGS

FIG. 1 is a flowchart illustrating a method for generating a bending path of an orthodontic wire according to an embodiment of the present invention.

FIG. 2 is a screen showing a virtual three-dimensional tooth model according to an embodiment of the present invention.

FIG. 3 is a screen for determining a maxillary or a mandible of a virtual 3D tooth model according to an embodiment of the present invention.

FIG. 4 is a screen showing an occlusal plane according to an embodiment of the present invention.

FIG. 5 is a screen showing a process of adjusting a position of an occlusal plane according to an embodiment of the present invention.

FIG. 6 is a screen showing a virtual plane according to an embodiment of the present invention.

FIG. 7 is a screen for setting a starting point and an ending point of a wire path according to an embodiment of the present invention.

FIG. 8 is a screen showing a path of a wire according to an embodiment of the present invention.

FIG. 9 is a screen showing a path of a wire according to another embodiment of the present invention.

FIG. 10 is a schematic diagram showing a wire according to an embodiment of the present invention.

### DETAILED DESCRIPTION

Hereinafter, specific embodiments of the present invention will be described with reference to the accompanying drawings. The following detailed description is provided to aid in a comprehensive understanding of the methods, devices and/or systems described herein. However, the detailed description is only for illustrative purposes and the present invention is not limited thereto.

In describing the embodiments of the present invention, when it is determined that detailed descriptions of known technology related to the present invention may unnecessarily obscure the gist of the present invention, the detailed descriptions thereof will be omitted. The terms used below are defined in consideration of functions in the present invention, but may be changed depending on the customary practice or the intention of a user or operator. Thus, the definitions should be determined based on the overall content of the present specification. The terms used herein are only for describing the embodiments of the present invention, and should not be construed as limitative. Unless expressly used otherwise, a singular form includes a plural form. In the present description, the terms “including”, “comprising”, “having”, and the like are used to indicate certain characteristics, numbers, steps, operations, elements, and a portion or combination thereof, but should not be interpreted to preclude one or more other characteristics, numbers, steps, operations, elements, and a portion or combination thereof.

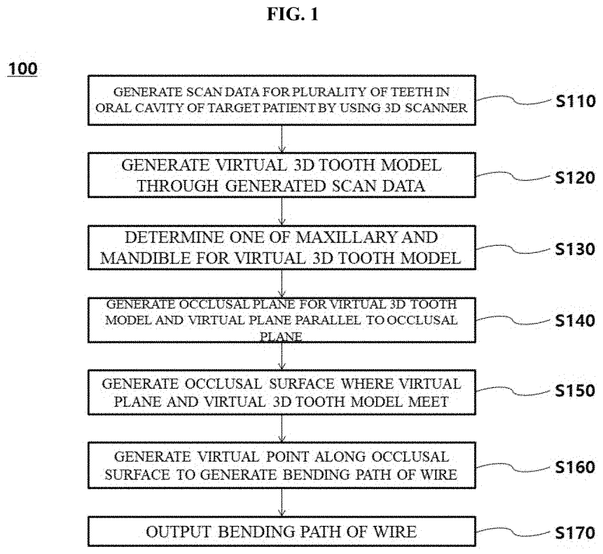

FIG. 1 is a flowchart illustrating a method 100 for generating a bending path of an orthodontic wire according to an embodiment of the present invention. In the illustrated flowchart, the method is divided into a plurality of steps; however, at least some of the steps may be performed in a different order, performed together in combination with other steps, omitted, performed in subdivided steps, or performed by adding one or more steps not illustrated.

Referring to FIG. 1, the method 100 for generating a bending path of an orthodontic wire according to an embodiment of the present invention includes generating scan data for a plurality of teeth in an oral cavity of a target patient by using a three-dimensional (3D) scanner (S110), generating a virtual 3D tooth model through the generated scan data (S120), determining one of a maxillary and a mandible for the virtual 3D tooth model (S130), generating an occlusal plane for the virtual 3D tooth model and a virtual plane parallel to the occlusal plane (S140), generating an occlusal surface where the virtual plane and the virtual 3D tooth model meet (S150), generating a virtual point along the occlusal surface to generate a bending path of a wire (S160), and outputting the bending path of the wire (S170).

Specifically, in step S110, the generating of the scan data may include acquiring a tooth shape for a plurality of teeth by using an impression material and then producing a gypsum model therefor, and generating the scan data by using the 3D scanner for the produced gypsum model.

In addition, the generating of the scan data may include generating the scan data for the plurality of teeth by directly using the 3D scanner in the oral cavity without producing the separate gypsum model.

In this case, since the process of producing the separate gypsum model may be omitted, the process of forming the wire may be further simplified.

In this case, the data acquired by the 3D scanner may be acquired in the form of being acquired from a computer and a peripheral device connected to the computer and recorded on a storage device, and may have a structure that is generated and stored as a 3D stereolithography (STL) file, for example.

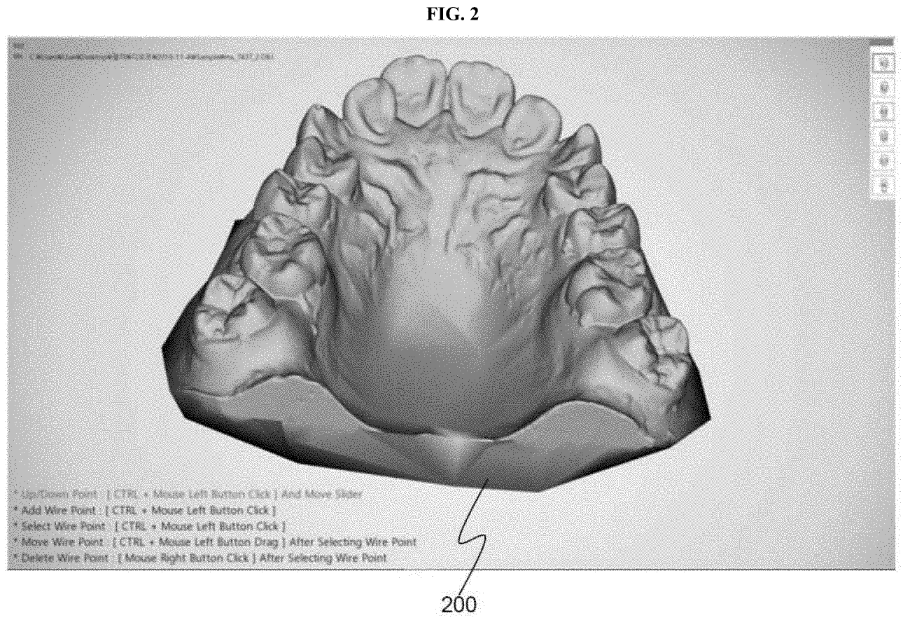

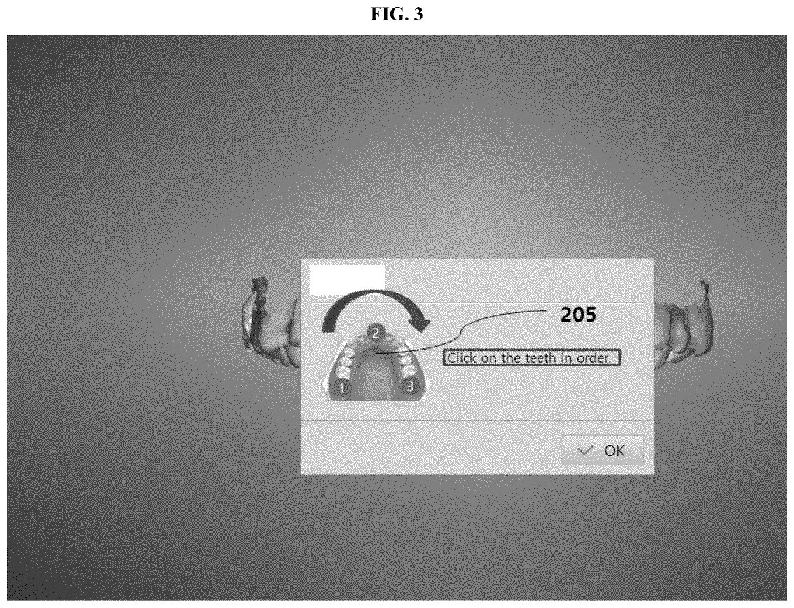

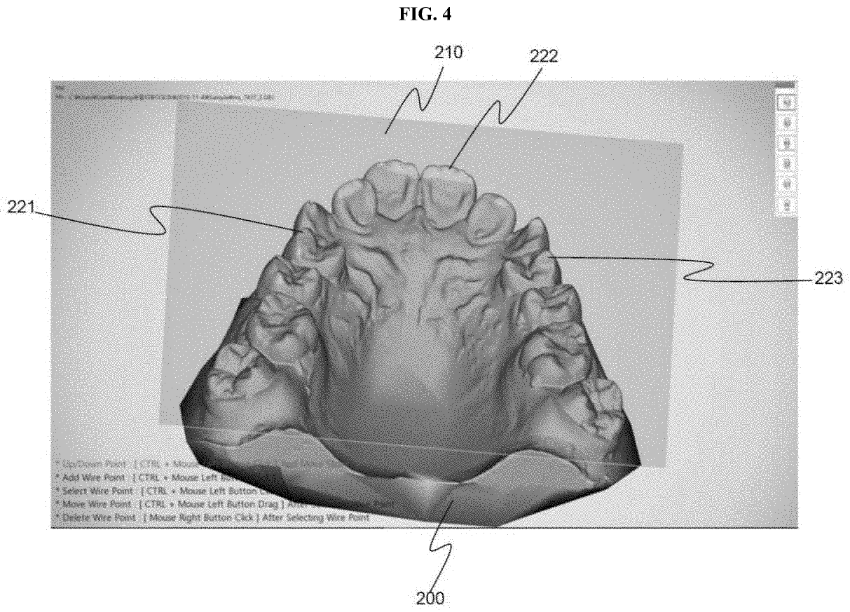

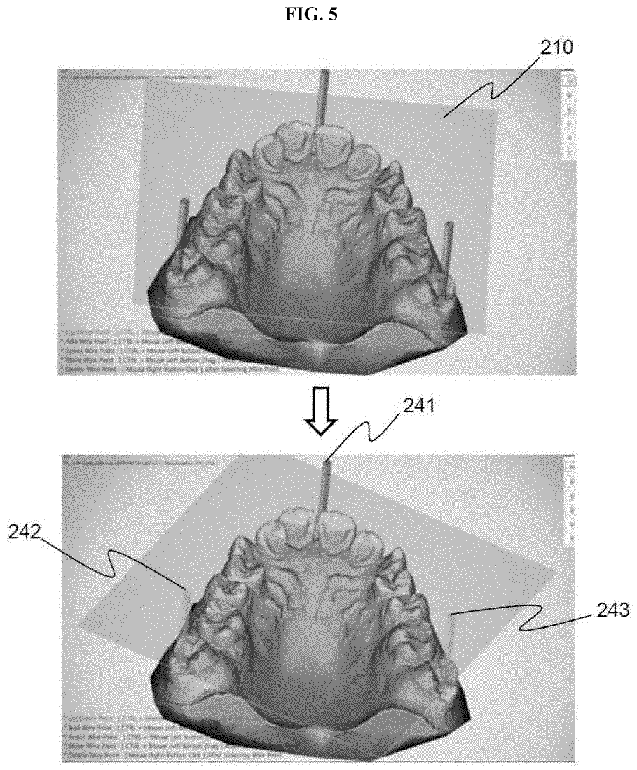

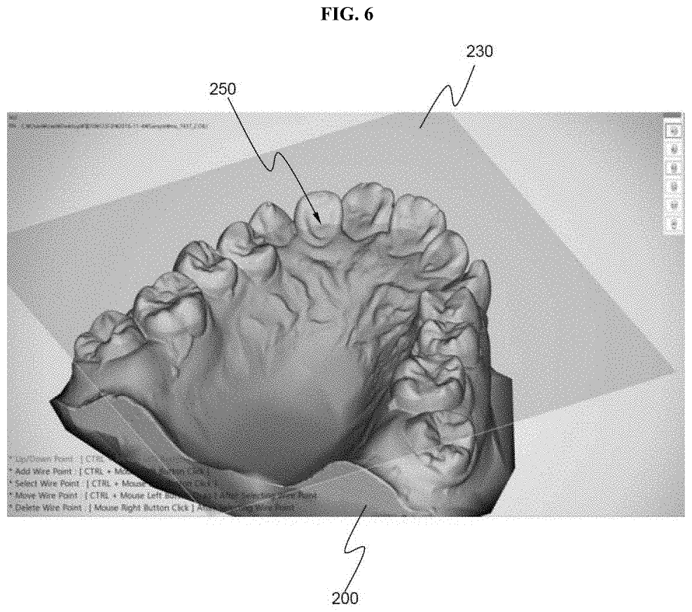

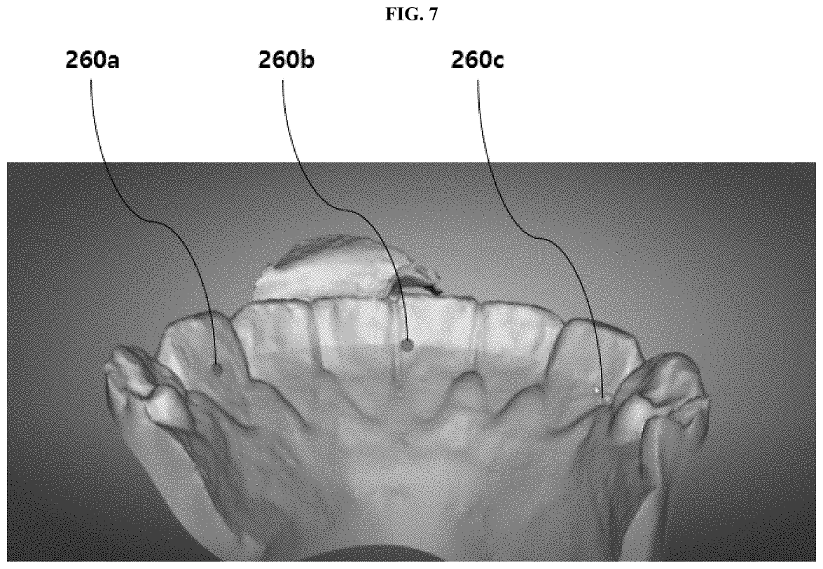

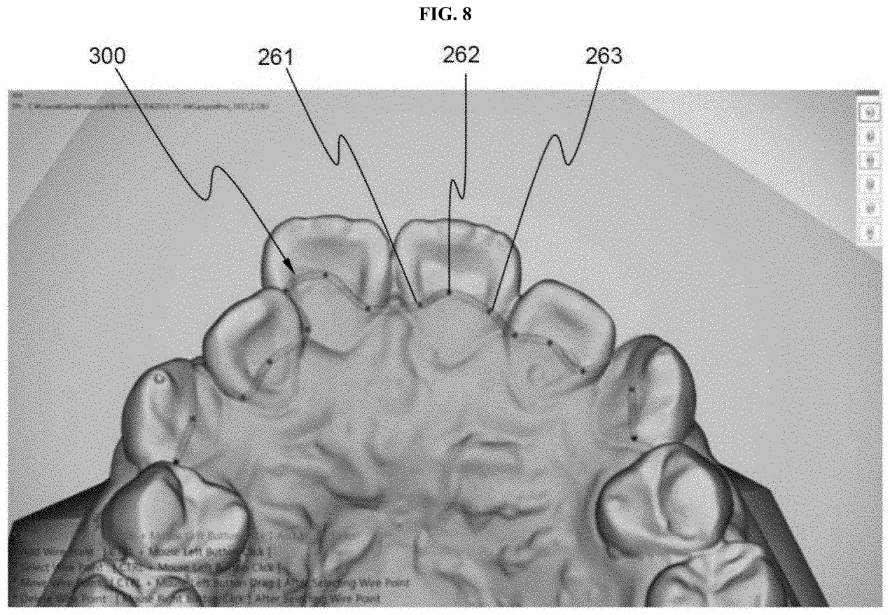

FIG. 2 illustrates a screen showing a virtual 3D tooth model according to an embodiment of the present invention, FIG. 3 illustrates a screen for determining a maxillary or a mandible of a virtual 3D tooth model according to an embodiment of the present invention, FIG. 4 illustrates a screen showing an occlusal plane according to an embodiment of the present invention, FIG. 5 illustrates a screen showing a process of adjusting a position of an occlusal plane according to an embodiment of the present invention, FIG. 6 illustrates a screen showing a virtual plane according to an embodiment of the present invention, FIG. 7 illustrates a screen showing a path of a wire according to an embodiment of the present invention, and FIG. 8 illustrates a screen showing a path of a wire according to an embodiment of the present invention.

First, referring to FIG. 2, scan data generated and stored as an STL file is loaded by a computer to form a virtual three-dimensional tooth model 200, and the virtual 3D tooth model 200 may be generated for each of a maxillary and a mandible of a plurality of teeth.

Referring to FIG. 3, in step S130, with respect to the virtual 3D tooth model 200, a determination is made whether the corresponding tooth model 200 is the maxillary or the mandible. In order to determine this, a mini screen 205 that is clickable by a user is displayed on a screen, and according to a direction in which three positions displayed on the corresponding mini screen 205 are selected, a determination may be made whether the virtual 3D tooth model 200 is the maxillary or the mandible. For example, when three positions are selected in a clockwise direction as illustrated in FIG. 3, the virtual 3D tooth model 200 may be determined as the maxillary, and when selected in a counterclockwise direction, the virtual 3D tooth model 200 may be determined as the mandible. However, the present invention is not limited thereto, and contrary to the previous example, the virtual 3D tooth model 200 may be determined as the maxillary when in the counterclockwise direction and as the mandible when in the clockwise direction.

Next, referring to FIG. 4, in step S140, an occlusal plane 210 generated for the virtual 3D tooth model 200 may be generated in a form in which three or more highest points of a plurality of teeth are connected. Specifically, as illustrated in FIG. 4, the occlusal plane 210 may be automatically generated in the form of a virtual plane obtained by connecting the three highest points 221, 222, and 223 of the plurality of teeth, and may be formed for each of the maxillary and the mandible of which the virtual 3D tooth model 200 is formed.

Next, a virtual plane 230 parallel to the occlusal plane 210 is generated. The virtual plane 230 is formed by forming arbitrary three axes 241, 242, and 243 with respect to the generated occlusal plane 210 and adjusting at least one of the inclination and the height of the axes by the user, as disclosed in FIG. 5.

Next, referring to FIG. 6, in step S150, an occlusal surface 250 where the virtual plane 230 generated by adjusting the position of the occlusal plane 210 and the virtual 3D tooth model 200 meet is generated, and as illustrated in FIG. 7, in order to set a starting point and an ending point of a bending path of a wire 300, the user may set points at at least three points 260a, 260b, and 260c. In addition, as disclosed in FIG. 8, in step S160, virtual point 261, 262, and 263 are generated at a position where the occlusal surface 250 passes with respect to a tooth surface of the virtual 3D tooth model 200 to generate the bending path of the wire 300.

In this case, at least three virtual points 261, 262, and 263 may be generated for each tooth, and specifically, as disclosed in FIG. 5, the virtual points 261, 262, and 263 may be composed of three or more points generated at a central portion 262 of the tooth and right and left borders 261 and 263 to the central portion.

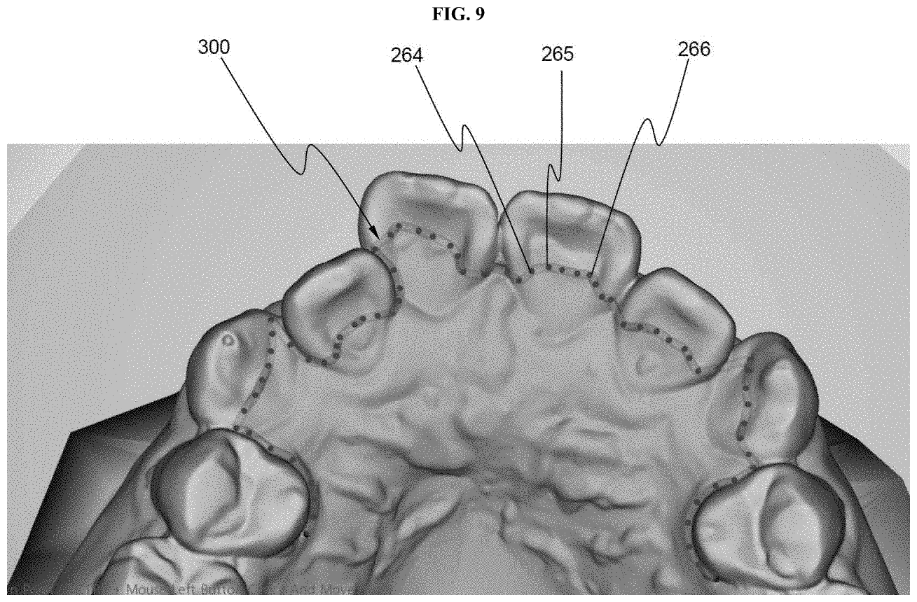

FIG. 9 illustrates a screen showing a path of a wire according to another embodiment of the present invention.

Referring to FIGS. 8 and 9, virtual points 261, 262, and 263 that generates the bending path of the wire 300 may be generated at 0.1 mm intervals on the right and left borders 261 and 263 based on the central portion 262 of the tooth, and as disclosed in FIG. 8, a more detailed path may be generated by adding virtual points 264, 265, and 266 between the three virtual points 261, 262, and 263.

In step S160, the bending path of the wire 300 may be changed by adjusting right, left, front, back, up, and down for each of the virtual points 261, 262, and 263 as necessary, and may have a configuration that is controlled in only one direction when the position of each of the virtual points 261, 262, and 263 is to be changed.

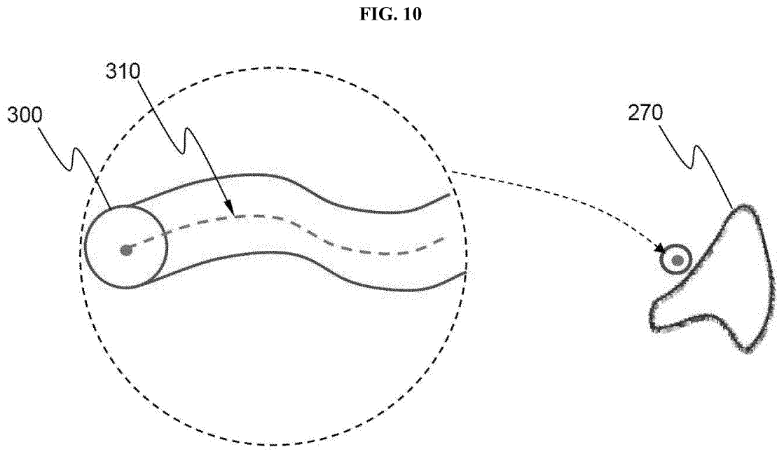

FIG. 10 illustrates a schematic diagram showing a wire according to an embodiment of the present invention.

Referring to FIGS. 8 and 10, in step S170, the thickness may be classified and output according to the type of the wire 300 used when outputting the bending path of the wire 300, and this configuration may be adjusted so as not to penetrate the teeth 270 depending on the thickness of the wire 300, as disclosed in FIG. 9. That is, the bending path of the wire 300 is generated such that the wire does not penetrate a boundary of the occlusal surface 250 by setting a thickness of the wire 300.

Therefore, the output data for the bending path of the wire 300 may be adjusted in a form generated on a line 310 connecting the center point of the vertical section of the wire 300 in consideration of the thickness of the wire 300.

Although the representative embodiments of the present invention have been described in detail as above, those skilled in the art will understand that various modifications may be made thereto without departing from the scope of the present invention. Therefore, the scope of rights of the present invention should not be limited to the described embodiments, but should be defined not only by the claims set forth below but also by equivalents of the claims.

1. A method for generating a bending path of an orthodontic wire, the method comprising:
generating scan data for a plurality of teeth in an oral cavity of a target patient by using a three-dimensional (3D) scanner;
generating a virtual 3D tooth model through the generated scan data;
determining one of a maxillary and a mandible for the virtual 3D tooth model;
generating an occlusal plane for the virtual 3D tooth model and a virtual plane parallel to the occlusal plane;
generating an occlusal surface where the virtual plane and the virtual 3D tooth model meet;
generating a virtual point along the occlusal surface to generate a bending path of a wire; and
outputting the bending path of the wire.

2. The method of claim 1, wherein the generating of the scan data includes acquiring a tooth shape by using an impression material for the plurality of teeth and then producing a gypsum model therefor, and generating the scan data by using the 3D scanner for the produced gypsum model.

3. The method of claim 1, wherein the generating of the scan data includes generating the scan data for the plurality of teeth by directly using the 3D scanner.

4. The method of claim 1, wherein the determining of one of the maxillary and the mandible for the virtual 3D tooth model is based on a direction in which a plurality of positions on the virtual 3D tooth model are selected.

5. The method of claim 4, wherein the plurality of positions are three in number.

6. The method of claim 1, wherein the occlusal plane of the 3D tooth model is a virtual plane obtained by connecting the three or more highest points of the plurality of teeth.

7. The method of claim 6, wherein the occlusal plane is formed for each of the maxillary and the mandible of the plurality of teeth.

8. The method of claim 1, wherein at least one of the inclination and height of the virtual plane is adjusted.

9. The method of claim 1, wherein the bending path of the wire generates at least three virtual points for each tooth.

10. The method of claim 9, wherein the virtual points are three or more points generated at a central portion of each tooth and right and left borders to the central portion.

11. The method of claim 10, wherein the virtual points are adjustable right, left, front, back, up, and down, and controlled in only one direction during the position movement.

12. The method of claim 10, wherein the virtual points are additionally generated between the central portion of each tooth and each of the right and left borders to the central portion.

13. The method of claim 1, wherein the bending path of the wire is generated such that the wire does not penetrate a boundary of the occlusal surface by setting a thickness of the wire.

14. The method of claim 1, wherein output data for the bending path of the wire corresponds to a line connecting a center point of a vertical section of the wire.

15. A computer storage medium storing a program for performing the method for generating a bending path of an orthodontic wire of claim 1.

16. A wire manufacturing apparatus comprising:
a control board for transforming coordinates for bending a wire through data output by the method for generating a bending path of an orthodontic wire of claim 1,
wherein a motor of a machine is controlled through the transformed coordinates, and the bending is performed with a shape of the wire designed through the transformed coordinates.

17. A wire manufactured by the wire manufacturing apparatus of claim 16.
